(19) United States
(12) Patent Application Publication
(10) Pub. No.: US 2007/0131407 A1
(43) Pub. Date: Jun. 14, 2007

(54) Air conditioning apparatus

(75) Inventor: Takuya Natsume, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/634,477

(22) Filed: Dec. 6, 2006

(30) Foreign Application Priority Data
Dec. 12, 2005 (JP) 2005-358206

(51) Int. Cl. B60H 1/00; B60H 3/00

(52) U.S. Cl. 165/202; 165/42

(57) ABSTRACT

An air conditioning apparatus for a vehicle has a first heat exchanger for cooling air, a second heat exchanger for heating air having passed through the first heat exchanger, a cool air adjusting door and a second air adjusting door in a case. The case defines a cool air passage downstream of the first heat exchanger to allow cool air to bypass the second heat exchanger. The cool air adjusting door is disposed to adjust the volume of cool air in the cool air passage. The case further defines an air mixing chamber directly downstream of the second heat exchanger. In a bi-level mode, the cool air is directed to the air mixing chamber by the cool air adjusting door. The case further defines a face opening and a foot opening at positions where air in the air mixing chamber can directly flow to the face opening and the foot opening in the bi-level mode.

### CROSS REFERENCE TO RELATED APPLICATION

This application is based on Japanese Patent Application No. 2005-358206 filed on Dec. 12, 2005, the disclosure of which is incorporated herein by reference.

### FIELD OF THE INVENTION

The present invention relates to an air conditioning apparatus for a vehicle for conditioning air to be introduced into a passenger compartment of the vehicle.

### BACKGROUND OF THE INVENTION

In an air conditioning apparatus for a vehicle, a flow rate control type and an air mixing type are generally known. In the former type, a flow rate of a hot water flowing in a heat exchanger for heating is controlled so as to control a temperature of air to be introduced into a passenger compartment of the vehicle. In this apparatus, however, a system or device for controlling the flow rate of the hot water is required, resulting in an increase of cost. In the latter type, a space for mixing cool air with hot air is required. Therefore, the overall size of the apparatus is likely to increase, while its structure is generally simple.

The air mixing type air conditioning unit is for example disclosed in Japanese Patent Publication No. 2001-180249. In the air conditioning apparatus, an evaporator and a heater core are housed in a unit case. The heater core is located downstream of the evaporator with respect to a flow of air. The unit case defines a cool air passage through which air having passed through the evaporator flows and bypasses the heater core.

In the cool air passage, a cool air adjusting door is provided to adjust the volume of air flowing in the cool air passage. Also, a hot air adjusting door is provided upstream of the heater core with respect to the flow of air so as to adjust the volume of air to be introduced to the heater core.

The unit case defines a hot air passage through which air having passed through the heater core flows at a position downstream of the heater core. Further, the unit case defines an air mixing chamber at a position downstream of the cool air passage and the hot air passage for mixing hot air and cool air. Also, openings such as a face opening and a foot opening for discharging air outside of the unit case are formed downstream of the air mixing chamber.

In the air conditioning apparatus, the air discharged from the heater core is introduced into the hot air passage and then into the air mixing chamber. Namely, both of the hot air passage and the air mixing chamber are defined between the heater core and the face and foot openings. Therefore, the size of the unit case is relatively large.

Also, a mechanism such as a guide wall is required to lead the hot air from the hot air passage toward the air mixing chamber. In the above air conditioning apparatus, the guide wall is provided by a wall that forms the foot opening.

### SUMMARY OF THE INVENTION

The present invention is made in view of the foregoing matter, and it is an object to provide a vehicle air conditioning apparatus with an air mixing structure, capable of reducing a size.

According to an aspect of the present invention, an air conditioning apparatus for a vehicle having a case, a first heat exchanger, a second heat exchanger, a cool air adjusting door and a hot air adjusting door. The first heat exchanger is disposed in the case for cooling air. The second heat exchanger is disposed downstream of the first heat exchanger with respect to a flow of air for heating air having passed through the first heat exchanger. The case defines a cool air passage downstream of the first heat exchanger to allow the air having passed through the first heat exchanger to bypass the second heat exchanger. The cool air adjusting door is disposed in the cool air passage for adjusting a volume of air flowing through the cool air passage. The hot air adjusting door is disposed upstream of the second heat exchanger for adjusting a volume of air to be introduced to the second heat exchanger.

The case further defines an air mixing chamber, a face opening and a foot opening. The air mixing chamber is defined directly downstream of the second heat exchanger for mixing air having passed through the second heat exchanger and air from the cool air passage therein. The foot opening and the face opening are defined at positions where the air having passed through the second heat exchanger flows in the foot opening and the face opening directly from the air mixing chamber in a bi-level mode. Further, the cool air adjusting door is disposed such that the air flowing through the cool air passage is directed toward the air mixing chamber in the bi-level mode.

In this construction, the air mixing chamber is arranged directly downstream of the second heat exchanger and the air of the cool air passage is directed to the air mixing chamber by the cool air adjusting door in the bi-level mode. Further, the foot opening and the face opening are defined such that the air in the air mixing chamber can directly flow to the foot opening and the face opening. Accordingly, a space from the second heat exchanger to the foot and face openings can be reduced. With this, a size of the air conditioning apparatus can be reduced. Further, even when the space from the second heat exchanger to the foot and face openings is reduced, mixing of cool air and hot air is facilitated by the cool air adjusting door. Furthermore, the temperature difference between the air discharged from the foot opening and the air discharged from the face opening can be appropriately created.

According to a second aspect of the present invention, an air conditioning apparatus for a vehicle has a case, a first heat exchanger disposed in the case for cooling air, and a second heat exchanger disposed downstream of the first heat exchanger with respect to a flow of air for heating air having passed through the first heat exchanger. The case defines a cool air passage to allow the air having passed through the first heat exchanger to bypass the second heat exchanger, and an air mixing chamber directly downstream of the second heat exchanger. The case further defines a first opening through which air to be blown toward a lower region of a passenger compartment of the vehicle is discharged and a second opening through which air to be blown toward an upper region of the passenger compartment is discharged. The first opening is opposed to the second heat exchanger. Further, a butterfly door is disposed in the cool air passage as a cool air adjusting door for adjusting a volume of air flowing through the cool air passage. The butterfly door has a first surface facing the second heat exchanger and a second surface opposite to the first surface. The butterfly door is arranged such that an end thereof is located more downstream than the second heat exchanger. Further, in a bi-level mode, the butterfly door is moved to a position where air flowing along the first surface in the cool air passage is directed toward the air mixing chamber by the first surface and air flowing along the second surface in the cool air passage is directed toward the second opening.

In the above construction, since the air mixing chamber is defined directly downstream of the second heat exchanger, a size of the case is reduced. Further, in the bi-level mode, since the end of the butterfly door is located more downstream of the second heat exchanger, cool air flowing along the first surface of the butterfly door is directed to the air mixing chamber and cool air flowing along the second surface of the butterfly door is directed to the second opening. Accordingly, in the bi-level mode, mixing of hot air and the cool air is facilitated. Also, a temperature difference between air discharged from the first opening and air discharged from the second opening can be appropriately created.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic cross-sectional view of an air conditioning section of an air conditioning apparatus in a bi-level mode according to an embodiment of the present invention;

FIG. 2 is a schematic cross-sectional view of the air conditioning section of the air conditioning apparatus taken along a line II-II in FIG. 1 for showing an example of a blocking portion;

FIG. 3 is a schematic cross-sectional view of the air conditioning section of the air conditioning apparatus, for showing another example of the blocking portion, according to the embodiment;

FIG. 4 is a schematic cross-sectional view of the air conditioning section of the air conditioning apparatus in a face mode according to the embodiment;

FIG. 5 is a schematic cross-sectional view of the air conditioning section of the air conditioning apparatus in a foot mode according to the embodiment;

FIG. 6 is a schematic cross-sectional view of the air conditioning section of the air conditioning apparatus, for showing a modified example of a first door and a second door, according to the embodiment; and

FIG. 7 is a schematic cross-sectional view of the air conditioning section of the air conditioning apparatus in the bi-level mode, for showing a modified example of a cool air adjusting door, according to the embodiment.

### DETAILED DESCRIPTION OF EXAMPLE EMBODIMENT

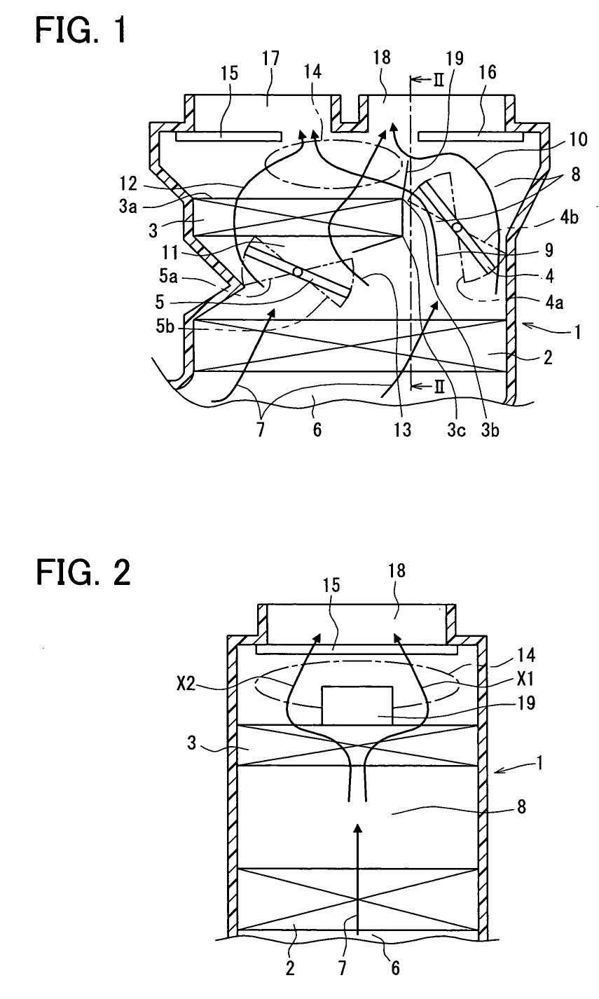

An embodiment of the present invention will now be described with reference to the drawings. An air conditioning apparatus shown in FIGS. 1 to 5 is for example used in vehicles such as cars for private use or business and commercial use. The air conditioning apparatus is constructed such that a condition of air inside a passenger compartment of the vehicle is automatically or manually controlled. Also, the air conditioning apparatus performs a face mode operation, a foot mode operation, a bi-level mode operation and the like. In a bi-level mode, the air conditioning apparatus conditions air by mixing cool air with hot air and blows the conditioned air into the passenger compartment.

The arrangement position of the air conditioning apparatus in the vehicle is not particularly limited. For example, the air conditioning apparatus can be used as a front air conditioning apparatus for air-conditioning a front region of the passenger compartment. Alternatively, the air conditioning apparatus can be used as a rear air conditioning apparatus for air-conditioning a rear region of the passenger compartment. In this case, the number of air blowing openings may be reduced, i.e., an air blowing opening for a defroster outlet is not necessary. Therefore, a size of the air conditioning apparatus can be reduced, as compared with the front air conditioning apparatus.

In the embodiment described hereafter, the air conditioning apparatus is for example used as the rear air conditioning apparatus. The air conditioning apparatus has an air conditioning unit for conditioning and blowing air toward the passenger compartment. FIG. 1 shows the air conditioning unit in the bi-level mode.

As shown in FIG. 1, the air conditioning unit has an air conditioning unit case (hereafter, unit case) 1 defining its outline. The air conditioning unit generally has a blower section (not shown) and an air conditioning section shown in FIG. 1. The unit case 1 has a foot opening 17 and a face opening 18 as air blowing openings in the air conditioning section. The unit case 1 is constructed of plural case members made of a resin such as polypropylene. The plural case members are for example connected to each other using fastening means such as metal springs and screws.

The blower section is provided with a blower unit for sucking air from the rear region of the passenger compartment and blowing it toward the air conditioning section. The blower section is in communication with an air passage 6 defined in the air conditioning section. The air passage 6 corresponds to an inlet portion of the air conditioning section.

The blower unit has a centrifugal multi-blade fan and a motor for driving the fan. The fan is housed in a scroll casing defining a duct extending on a radial outside of the fan and being in communication with the air passage 6.

The air conditioning unit is for example arranged in a trunk room of the vehicle on a rear side of the passenger compartment. The blower section is in communication with the passenger compartment through a duct. For example, a first end of the duct is in communication with a suction opening defined on a top surface of a package tray provided on the rear side of a rear passenger seat. Also, a second end of the duct is coupled to a suction port of the blower unit.

The face opening 18 and the foot opening 17 are in communication with the passenger compartment through air conditioner ducts coupled thereto. For example, the face opening 18 is in communication with a roof-side air blowing outlet defined on a side of a ceiling of the vehicle through the air conditioner duct. Thus, the air conditioned in the air conditioning unit is introduced into the air conditioner duct through the face opening 18 and is blown toward an upper body of a passenger, i.e., an upper area of the passenger compartment from the roof-side air blowing outlet.

The foot opening 17 is in communication with a foot air blowing outlet defined adjacent to a floor of the vehicle through the air conditioner duct. Thus, the air conditioned in the air conditioning unit is introduced into the air conditioner duct through the foot opening 17 and is blown toward feet of a passenger, i.e., a lower area of the passenger compartment from the foot air blowing outlet.

The air conditioning section has an evaporator 2 as a heat exchanger for cooling air 7 introduced into the passage 6 and a heater core 3 as a heat exchanger for heating air having passed through the evaporator 2. Also, the unit case 1 defines a cool air passage 8 through which the air (cool air 9, 10) having passed through the evaporator 2 bypasses the heater core 3.

Further, the air conditioning section has a cool air adjusting door 4 and a hot air adjusting door 5. The cool air adjusting door 4 is disposed in the cool air passage 8 for adjusting the volume of cool air 9, 10 flowing through the cool air passage 8. The hot air adjusting door 5 is provided to adjust the volume of air to be introduced into the heater core 3. Also, the unit case 1 has an air mixing chamber 14 in which the cool air 9, 10 and hot air 12, 13 having passed through the heater core 3 mix with each other.

The air mixing chamber 14 is defined directly downstream of the heater core 3 with respect to the flow of the hot air 12, 13. Namely, a downstream side of the heater core 3 directly faces the air mixing chamber 4. Thus, the hot air 12, 13 having passed through the heater core 3 directly flows in the air mixing chamber 14.

Further, the foot opening 17 and the face opening 18 are located at positions directly downstream of the air mixing chamber 14. In other words, the foot opening 17 and the face opening 18 are open to the air mixing chamber 14 such that the air in the air mixing chamber 14 can directly flow to the foot opening 17 and the face opening 18, particularly, in the bi-level mode.

That is, the foot opening 17 and the face opening 18 are located at positions where the hot air having passed through the heater core 3 can flow to the foot opening 17 and the face opening 18 by its inertial force in the bi-level mode. Further, the cool air passage 8 is disposed such that the cool air 9, 10 is directed toward the air mixing chamber 14 by the cool air adjusting door 14 in the bi-level mode.

The evaporator 2 is disposed entirely across the passage 6 in the unit case 1 so as to receive the air 7 blown by the blower unit. The evaporator 2 is for example arranged in a transverse direction. The evaporator 2 performs heat exchange between the air 7 and a low temperature and low pressure refrigerant, which has been decompressed in an expansion valve of a refrigerating cycle, flowing therein. As such, the air 7 is cooled with evaporation of the refrigerant.

The heater core 3 is disposed downstream of the evaporator 2 with respect to the flow of air 7. The heater core 3 performs heat exchange between the cool air 7 having passed through the evaporator 2 and a high temperature water for cooling an engine for traveling, thereby to heat the air 7.

Further, the heater core 3 is arranged partly across a passage downstream of the evaporator 2 such that the cool air passage 8 is defined in the unit case 1. The hot air adjusting door 5 is disposed downstream of the evaporator 2 and upstream of the heater core 3. The hot air adjusting door 5 is operated to adjust a ratio of the volume of air to be introduced to the heater core 3 to the volume of air to be introduced to the cool air passage 8. In the unit case 1, a passage defined downstream of the evaporator 2 separates into a hot air passage 11 communicating with the heater core 3 and the cool air passage 8 bypassing the heater core 3.

The hot air adjusting door 5 is for example a butterfly door having two door plates extending from a rotation axis thereof in radially different direction. The hot air adjusting door 5 is movable between a first position 5a and a second position 5b. When the hot air adjusting door 5 is at the first position 5a, the hot air passage 11 is closed. On the other hand, when the hot air adjusting door 5 is at the second position 5b, the hot air passage 11 is fully open.

Here, the hot air adjusting door 5 is not limited to the butterfly door. For example, the hot air adjusting door 5 can be a one-side holding type door having a door plate extending from a rotation shaft only on one side. Alternatively, the hot air adjusting door 5 can be a slide door operated in a sliding manner to open and close the hot air passage 11.

The cool air adjusting door 4 is disposed to adjust the volume of air passing through the cool air passage 8. The cool air adjusting door 4 is for example a butterfly door having two door plates radially extending from a rotation axis thereof in different directions. The cool air adjusting door 4 is movable between a first position 4a and a second position 4b.

When the cool air adjusting door 4 is at the first position 4a, the cool air passage 8 is fully open. On the other hand, when the cool air adjusting door 4 is at the second position 4b, the cool air passage 8 is closed. Further, the cool air adjusting door 4 is arranged such that its downstream end is positioned to a downstream end portion 3b of the heater core 3 when the cool air adjusting door 4 is operated to the second position 4b. For example, the end of the cool air adjusting door 4 contacts a downstream corner of the heater core 3a or a downstream portion of a side wall of the heater core 3, the side wall facing the cool air adjusting door 4, thereby to provide a sealing portion.

In other words, the rotation shaft of the cool air adjusting door 4 is positioned such that the end of the cool air adjusting door 4 is located more downstream than the downstream end portion 3b with respect to the flow of air when the cool air adjusting door 4 opens the cool air passage 8.

In a case that the cool air adjusting door 4 is disposed such that the end contacts an upstream end portion 3c of the heater core 3 when closing the cool air passage 8, the end of the cool air adjusting door 4 is located at a more upstream position than the position illustrated in FIG. 1 in the bi-level mode. In this case, it is difficult to facilitate the cool air 9, which flows along a first surface of the cool air adjusting door 4 facing the side wall of the heater core 3, toward the air mixing chamber 14. Therefore, it is difficult to reduce the temperature of air discharged from the foot opening 17. As a result, the temperature difference between the air blown from the foot air blowing outlet and the air blown from the face air blowing outlet largely increases.

In the embodiment shown in FIG. 1, on the other hand, even when an opening degree of the cool air adjusting door 4 is small, i.e., the cool air adjusting door 4 slightly opens the cool air passage 8 in the bi-level mode, the end of the cool air adjusting door 4 is located more downstream than an air blowing surface 3a of the heater core 3 through which the air is discharged from the heater core 3. That is, in FIG. 1, the end of the cool air adjusting door 4 is located diagonally upward of the downstream end portion 3b of the heater core 3, and extends toward the air mixing chamber 14.

As such, the cool air 9 flowing along the first surface of the cool air adjusting door 4 is directed toward the air mixing space 14 by the cool air adjusting door 4. Namely, the flow of the cool air 9 toward the air mixing space 14 is facilitated by the cool air adjusting door 4. As a result, the temperature of air discharged from the foot opening 17 can be reduced. Accordingly, it is easy to adjust the temperature difference between the air discharged from the foot air blowing outlet and the air discharged from the face air blowing outlet.

This construction is also effective when the volume of cool air 9 flowing along the first surface of the cool air adjusting door 4 is small, i.e., the opening degree of the cool air adjusting door 4 is small because a flow speed of the cool air 9 increases.

As described above, the air mixing chamber 14 is defined directly downstream of the heater core 3. In other words, the air discharge surface 3a of the heater core 3 faces or is exposed to the air mixing chamber 14. In the bi-level mode, the hot air having passed through the heater core 3 and the cool air 9 are directed to intersect each other and mixed in the air mixing chamber 14.

To enhance the mixing of the cool air and the hot air so as to adjust the temperature difference between the air blown from the foot blowing outlet and the air blown the face blowing outlet (e.g., approximately 15 to 20 degrees Celsius), it is generally preferable to increase the size of the air mixing chamber. However, this results in an increase in the size of the unit case.

In the embodiment shown in FIG. 1, on the other hand, the air conditioning unit has the structure capable of enhancing the mixing of the hot air and the cool air without increasing the bulk of the air mixing chamber 14 and without requiring additional members such as a guide wall for guiding the hot air toward the air mixing chamber 14 downstream of the heater core 3 and a specific passage for leading the hot air toward the air mixing chamber 14. This structure of the air conditioning unit of the embodiment contributes to provide a compact air conditioning unit.

Also, since the mixing of the hot air and the cool air is facilitated, the temperature of air discharged from the foot opening 17 is easily reduced. As a result, a function of adjusting the temperature difference improves. Further, since the butterfly door is employed as the cool air adjusting door 4, the amount of cool air 10 flowing along a second surface of the cool air adjusting door 4 toward the face opening 18 can be adjusted, the second surface being opposite to the first surface. Therefore, the temperature difference between the air blown from the foot air blowing outlet and the air blown from face air blowing outlet can be easily adjusted.

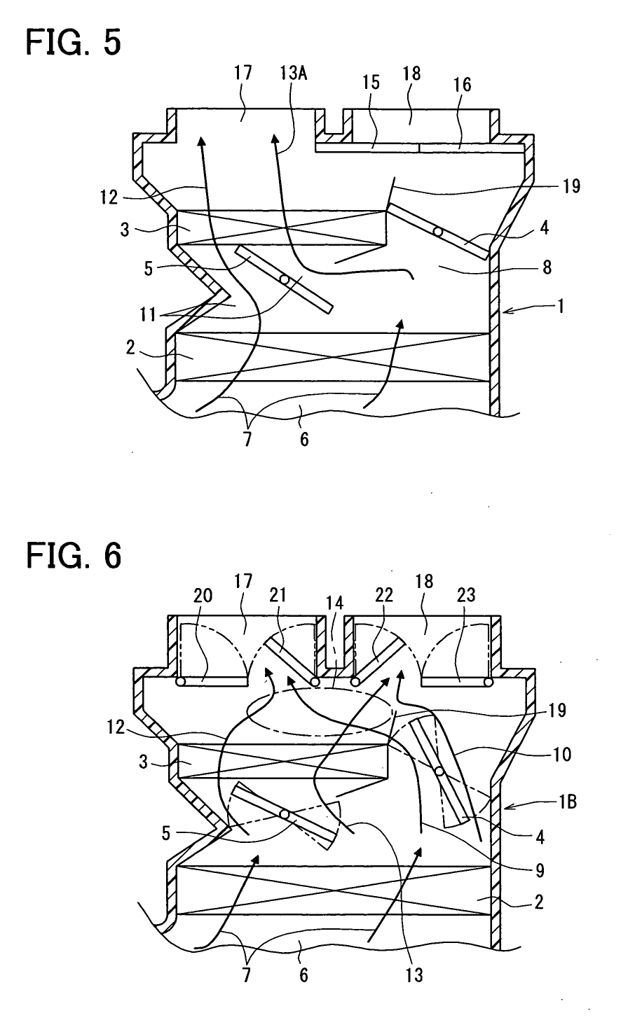

The foot opening 17 is located next to the face opening 18. The foot opening 17 is located closer to the heater core 3, as compared with the face opening 18. A foot opening door 15 as a first door is provided adjacent to the foot opening 17 to open and close the foot opening 17. For example, the foot opening door 15 is movable to a first position where the foot opening 17 is fully open (e.g., in FIG. 5), a second position where the foot opening 17 is fully closed (e.g., in FIG. 4) and a third position where a substantially half of the foot opening 17 is closed (e.g., in FIG. 1).

The face opening 18 is located further from the heater core 3, as compared with the foot opening 17. A face opening door 16 as a second door is provided adjacent to the face opening 18 to open and close the face opening 18. For example, the face opening door 16 is movable to a first position where the face opening 18 is fully open (e.g., in FIG. 4), a second position where the face opening 18 is fully closed (e.g., in FIG. 5), and a third position where a substantially half of the face opening 18 is open (e.g., in FIG. 1).

Further, the foot opening 17 is preferably located to generally oppose the air discharge surface 3a of the heater core 3. Also, the face opening 18 is preferably located to generally oppose the air discharge surface 3a of the heater core 3.

In the bi-level mode, the foot opening door 15 is operated to the third position where the half of the foot opening 17 is open, the half being adjacent to the face opening 18. Also, the face opening door 16 is operated to the third position where the half of the face opening 18 is open, the half being adjacent to the foot opening 17. In this construction, because the hot air and the cool air flow in directions to merge together, the mixing of the hot air and the cool air is facilitated.

The foot opening door 15 and the face opening door 16 are constructed of slide doors such as winding-type slide door, flexible slide door, and layered-type slide doors, which do not require mounting spaces in a direction parallel to the air flow direction, i.e., the up and down direction in FIG. 1.

In addition, the above air conditioning apparatus can have a blocking portion 19 for partly reducing a passage area of the cool air 9 flowing from the cool air passage 8 toward the air mixing chamber 14. As shown in FIGS. 1 and 2, the blocking portion 19 is a plate member.

As shown in FIG. 2, the blocking portion 19 is located at a substantially middle portion of a passage extending from the cool air passage 8 toward the air mixing chamber 14. For example, the blocking portion 19 extends from a substantially middle portion of the upstream end portion 3b of the heater core 3 so as to partly block the passage.

In this case, the cool air 9 separates into two flows on both sides of the blocking portion 19, as shown by arrows X1, X2 and flows into the air mixing chamber 14. By this construction, the flow of cool air 9 toward the air mixing chamber 14 is further facilitated and the mixing of the cool air 9 with the hot air is further improved. As a result, the function of adjusting the temperature difference between the air blown from the foot blowing outlet and the air blown from the face blowing outlet improves.

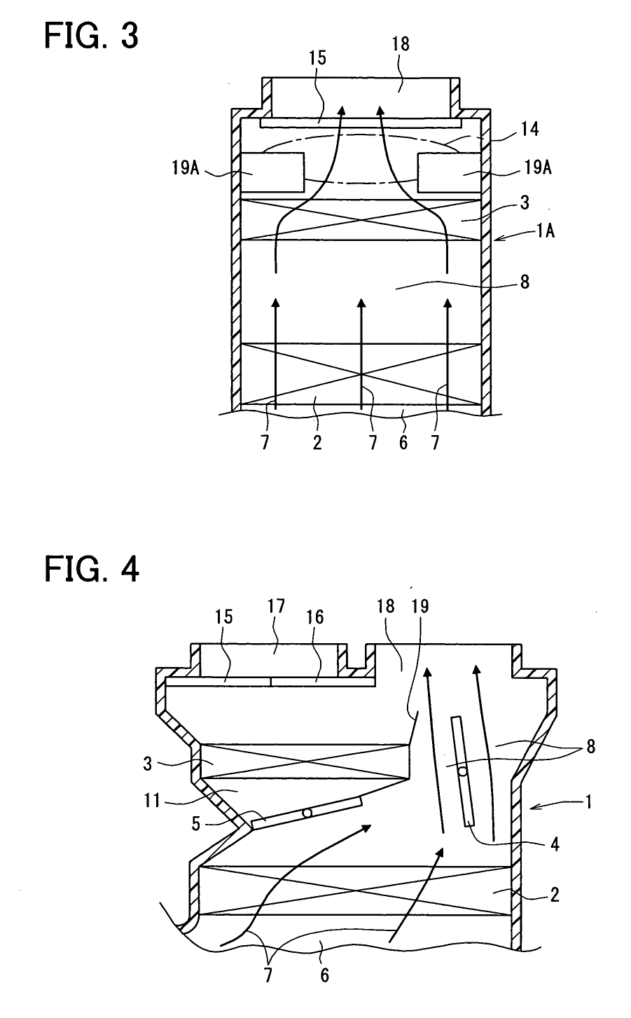

The arrangement of the blocking portion 19 can be changed in different manner. For example, two blocking portions 19A can be provided instead of the blocking portion 19, as shown in FIG. 3. The blocking portions 19A extend from inner walls of a unit case 1A at positions corresponding to ends of the heater core 3.

In this case, the cool air flowing through the cool air passage 8 is concentrated to a substantially middle portion defined between the two blocking portions 19A and enters the air mixing chamber 14. As such, the flow of cool air entering the air mixing chamber 14 is facilitated and further the mixing of the cool air 9 with the hot air is improved. In addition, this arrangement of the blocking portions 19A facilitates the flow of hot air toward the face opening 18. Accordingly, the function of adjusting the temperature differences between the air blown from the foot air blowing outlet and the air blown from the face air blowing outlet improves.

The shapes and sizes of the blocking portions 19, 19A can be adjusted so as to adjust the temperature difference between the air blown from the foot blowing outlet and the air blown from the face blowing outlet to a desired value.

The blocking portions 19, 19A can have the shapes extending substantially parallel to the flow of cool air in the face mode. In this case, the flow resistance of the cool air can be reduced, in addition to the function of improving the mixing of the cool air with the hot air.

The blocking potions 19A can be integrally formed into the unit case 1A. In this case, the number of parts is reduced. Also, the blocking portions 19A can be integrally molded with the unit case 1A.

Next, operations of the above air conditioning apparatus in the face mode and the foot mode will be described with reference to FIGS. 4 and 5. In the face mode, the foot opening door 15 and the face opening door 16 cover the foot opening 17, as shown in FIG. 4. Namely, the foot opening 17 is closed with both the foot opening door 15 and the face opening door 16. On the other hand, the face opening 18 is fully open. Also, the cool air adjusting door 4 is operated to a position where the cool air passage 8 is open.

Furthermore, in a maximum cooling operation, the cool air adjusting door 4 is operated to the first position 4a where the cool air passage 8 is fully open and the hot air adjusting door 5 is operated to the first position 5a where the hot air passage 11 is fully closed.

In this face mode, the air 7 forcibly introduced in the air passage 6 by the operation of the blower unit is cooled through the evaporator 2. Then, the cooled air 7 flows through the cool air passage 8 along the surfaces of the cool air adjusting door 4, further flows into the air conditioning duct through the face opening 18, and then is blown into the passenger compartment from the face air blowing outlet.

Next, in the foot mode, the foot opening door 15 and the face opening door 16 cover the face opening 18, as shown in FIG. 5. Namely, the face opening 18 is closed with both the foot opening door 15 and the face opening door 16. On the other hand, the foot opening 17 is fully open. Also, the hot air adjusting door 5 is operated to a position where the hot air passage 11 is open.

Further, in a maximum heating operation, the hot air adjusting door 5 is operated to the second position 5b where the hot air passage 11 is fully open. On the other hand, the cool air adjusting door 4 is operated to the second position 4b where the cool air passage 8 is fully closed.

In the foot mode, the air 7 forcibly introduced to the air passage 6 by the blower unit is cooled through the evaporator 2 and then introduced to the heater core 3 through the hot air passage 11. Then, the air is heated through the heater core 3 and introduced to the foot opening 17. As such, the air is blown into the passenger compartment from the foot air blowing opening.

The above embodiment can be modified in other ways. For example, the first door and the second door can be constructed of doors that are rotatable about rotation shafts, instead of the sliding-type doors 15, 16. As shown in FIG. 6, a first foot opening door 20 and a second foot opening door 21 are provided in a unit case 1B as the first door for opening and closing the foot opening 17. Also, a first face opening door 22 and a second face opening door 23 are provided in the unit case 1B as the second door for opening and closing the face opening 18.

In the bi-level mode, the half of the foot opening 17 is open by opening the second foot opening door 21 that is located adjacent to the face opening 18, and the half of the face opening 18 is open by opening the first face opening door 22 that is located adjacent to the foot opening 17. At this time, the first foot opening door 20 and the second face opening door 23 are located at closing positions.

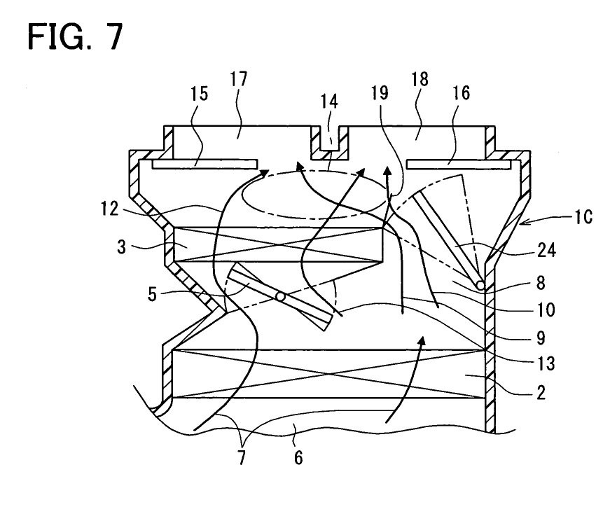

Further, the cool air adjusting door 4 can be constructed of a one-side holding type door 24, which has a door plate extending from a rotation shaft on one side, instead of the butterfly door, as shown in FIG. 7. For example, the door 24 is arranged such that a rotation shaft is located adjacent to an inner wall of a unit case 1C, and rotationally moved about the rotation shaft.

The exemplary embodiment of the present invention is described above. However, the present invention is not limited to the above embodiment, but may be implemented in other ways without departing from the spirit of the invention.

What is claimed is:

1. An air conditioning apparatus for a vehicle, comprising:
a case defining a foot opening and a face opening;
a first heat exchanger disposed in the case for cooling air;
a second heat exchanger disposed downstream of the first heat exchanger with respect to a flow of air for heating air having passed through the first heat exchanger, wherein the case defines a cool air passage downstream of the first heat exchanger to allow the air having passed through the first heat exchanger to bypass the second heat exchanger;
a cool air adjusting door disposed in the case to adjust a volume of air flowing through the cool air passage; and
a hot air adjusting door disposed in the case to adjust a volume of air to be introduced to the second heat exchanger, wherein
the case further defines an air mixing chamber directly downstream of the second heat exchanger for mixing air having passed through the second heat exchanger and air from the cool air passage therein,
the foot opening and the face opening are defined at positions where the air having passed through the second heat exchanger flows in the foot opening and the face opening directly from the air mixing chamber in a bi-level mode, and
the cool air adjusting door is disposed such that the air flowing through the cool air passage is directed toward the air mixing chamber in the bi-level mode.

2. The air conditioning apparatus according to claim 1, wherein
the second heat exchanger defines an air discharge surface through which the air is discharged into the air mixing chamber, and
the foot opening and the face opening are located at positions substantially opposed to the air discharge surface of the second heat exchanger.

3. The air conditioning apparatus according to claim 1, further comprising:
a first door for opening and closing the foot opening; and
a second door for opening and closing the face opening, wherein
in the bi-level mode, the first door is moved to a position where a portion of the foot opening is open, the portion being adjacent to the face opening, and the second door is moved to a position where a portion of the face opening is open, the portion being adjacent to the foot opening.

4. The air conditioning apparatus according to claim 1, wherein
the cool air adjusting door is movable between a first position where the cool air passage is open and a second position where the cool air passage is closed, and
when the cool air adjusting door is at the second position, an end of the cool air adjusting door is located at a downstream end portion of the second heat exchanger.

5. The air conditioning apparatus according to claim 1, further comprising:
a blocking portion disposed at a position adjacent to the second heat exchanger in the cool air passage to partly across a passage to the air mixing chamber.

6. The air conditioning apparatus according to claim 5, wherein
the blocking portion extends in a direction substantially parallel to a direction of a flow of the air from the cool air passage to the face opening in a face mode.

7. The air conditioning apparatus according to claim 5, wherein
the blocking portion is integrated with the case.

8. The air conditioning apparatus according to claim 1, wherein
the foot opening and the face opening are in communication with a rear space of a passenger compartment of the vehicle for air-conditioning the rear space of the passenger compartment.

9. The air conditioning apparatus according to claim 1, wherein
the cool air adjusting door is a door defining a rotation axis and having plate portions extending from the rotation axis in different directions.

10. The air conditioning apparatus according to claim 3, wherein the first door and the second door are slide doors.

11. An air conditioning apparatus for conditioning air to be introduced into a passenger compartment of a vehicle, comprising:
a case defining a first opening through which air to be blown toward a lower region of the passenger compartment flows and a second opening through which air to be blown toward an upper region of the passenger compartment flows;
a first heat exchanger disposed in the case for cooling air;
a second heat exchanger disposed downstream of the first heat exchanger for heating air having passed through the first heat exchanger;
a cool air passage defined by the case to allow the air having passed through the first heat exchanger to bypass the second heat exchanger;
an air mixing chamber defined in the case directly downstream of the second heat exchanger;
a cool air adjusting door disposed in the cool air passage for adjusting a volume of air flowing through the cool air passage, the cool air adjusting door defining being a butterfly door having plate portions extending from a rotation axis in different directions and defining a first surface facing the second heat exchanger and a second surface opposite to the first surface, wherein
the first opening is opposed to the second heat exchanger through the air mixing chamber, and the second opening is located adjacent to the first opening,
the cool air adjusting door is arranged such that an end thereof is located more downstream than the second heat exchanger, and
in a bi-level mode, the cool air adjusting door is moved to a position where air flowing along the first surface in the cool air passage is directed toward the air mixing chamber by the first surface and air flowing along the second surface in the cool air passage is directed toward the second opening by the second surface.
